(19) United States
(12) Patent Application Publication
(10) Pub. No.: US 2006/0109112 A1
(43) Pub. Date: May 25, 2006

(54) Remote control location technique and associated apparatus

(75) Inventor: Russell John Haines, Bristol (GB)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 11/068,795

(22) Filed: Mar. 2, 2005

(30) Foreign Application Priority Data
Mar. 3, 2004 (GB) 0404814.6

(51) Int. Cl. G08B 1/08; G08B 5/22

(52) U.S. Cl. 340/539.32; 340/539.13; 340/825.49

(57) ABSTRACT

In a network comprising a plurality of electronic devices, a processor for use in locating one or more remote control devices, each remote device comprising a transmitter configured to transmit wireless signals, each of the electronic devices having a receiver configured to receive signals transmitted by each of the one or more remote device, the processor comprising: means configured to receive signal information from the electronic devices, the signal information relating to signals transmitted by at least one of the one or more remote devices, as received the respective terminal; means for determining a positional measurement from the received signal information; and means for estimating a location of the at least one remote device, using the positional measurement or measurements.

The present invention relates to systems and methods for locating remote devices in a home or office environment, and particularly to systems and methods for locating remote controls of electronic equipment, such as home entertainment equipment.

A common problem in contemporary living environments is that remote controller devices for electronic equipment are easily lost. These devices are easily knocked down the side of coffee tables or slide down under cushions on a sofa. Further, in a household with many family members, numerous people are handling and using the devices, and so they are regularly misplaced. Small children or pets are another disruptive factor. Remote controls are increasingly becoming critical for the operation of complex home entertainment equipment, so their loss is extremely undesirable.

One known solution proposed to this problem concerns the addition of “beeper” circuitry to the remote controls, activated from the associated item of home entertainment equipment. Once activated, the device makes a repetitive sound to aid in its location. U.S. Pat. No. 5,598,143 and US patent application number 2002/024449 are examples of this approach.

A disadvantage to the “beeper” approach is the drain on the battery required to sound the transducer for a period of time long enough to enable the recovery of the controller. Particularly where the beeper needs to be used to locate the device on a daily basis, the beeper shortens the battery life of the device considerably. As such, a solution that does not involve a sounder/loudspeaker, or at least reduces the need for the beeper to be used in finding the device, would be desirable.

In one aspect, the present invention provides, in a network comprising a plurality of electronic devices, a processor for use in locating one or more remote control devices, each remote device comprising a transmitter configured to transmit wireless signals, each of the electronic devices having a receiver configured to receive signals transmitted by each of the one or more remote device, the processor comprising:

means configured to receive signal information from the electronic devices, the signal information relating to signals transmitted by at least one of the one or more remote devices, as received by the respective terminal;

means for determining a positional measurement from the received signal information; and

means for estimating a location of the at least one remote device, using the positional measurement or measurements.

Preferably the processor further comprises a user interface configured to allow a user to select one or more remote control devices to be located. It is also preferable that the processor comprise a database configured to maintain a record of at least one of: the last known location of each of the one or more remote controls; or a location history for each of the one or more remote controls.

In a second aspect, the present invention provides, in a local area network, the network comprising a plurality of electronic devices and at least one remote control device associated with one of the electronic devices, a method of locating the at least one remote device comprising:

receiving signal information from the electronic devices, the signal information relating to a signal transmitted by at least one of the remote devices, as received by the respective terminal;

determining a positional measurement from the received signal information; and

estimating a location of the remote device, using the positional measurement or measurements.

Therefore in this way, these aspects of the invention not only utilises radio communications to locate a remote control in a given area, but provides a user with a visual illustration of the estimated location via a graphical user interface. This interface also provides the user with various other interactive features, enabling them to locate a number of different devices at one time and also to maintain a general monitor on the location of the remote controls, particularly ones that are regularly lost. This functionality is preferably provided using an interface with the user's existing electronic equipment, such as existing home entertainment equipment. In a third aspect, the present invention provides a method of creating a system configured to locate a remote control device, the remote control device configured to remotely operate an electronic device, the method comprising:

arranging a plurality of electronic devices in a network;

associating each of the plurality of electronic devices with a receiver, each receiver configured to receive signals transmitted by the remote control device;

associating a processor with the plurality of electronic devices, such that each of the plurality of electronic devices is in communicable relation with the processor and provide the processor with the received signals, and wherein the processor is configured to estimate a location of the remote control device using the received signals and information on the relative location of the plurality of electronic devices.

Preferably this third aspect of the invention further comprises associating the processor with a user interface configured to allow a user to select one or more remote control devices to be located, each remote control device configured to remotely operate one or more of the plurality of electronic devices. It is also preferable that the method further comprises associating the processor with a graphical user interface configured to provide a user with a visual indication of the location of a remote control device.

Another preferred feature of this third aspect is to associate the processor with a database configured to store information on the location of the one or more remote control devices. Preferably the database is configured to store at least one of:

the last known location of each of the one or more remote controls; or a location history for each of the one or more remote controls.

In a further aspect the present invention provides a remote control device configured to transmit location information upon receiving a user input command.

Preferably in this further aspect of the present invention the remote control device comprises a radio frequency signal transmitter, configured to transmit radio frequency signals to one or more associated electronic devices. In a preferred aspect, the transmitter is a Bluetooth™ transmitter, configured to transmit Bluetooth™ compatible signals.

Embodiments of the present invention will now be described with reference to the accompanying drawings in which:

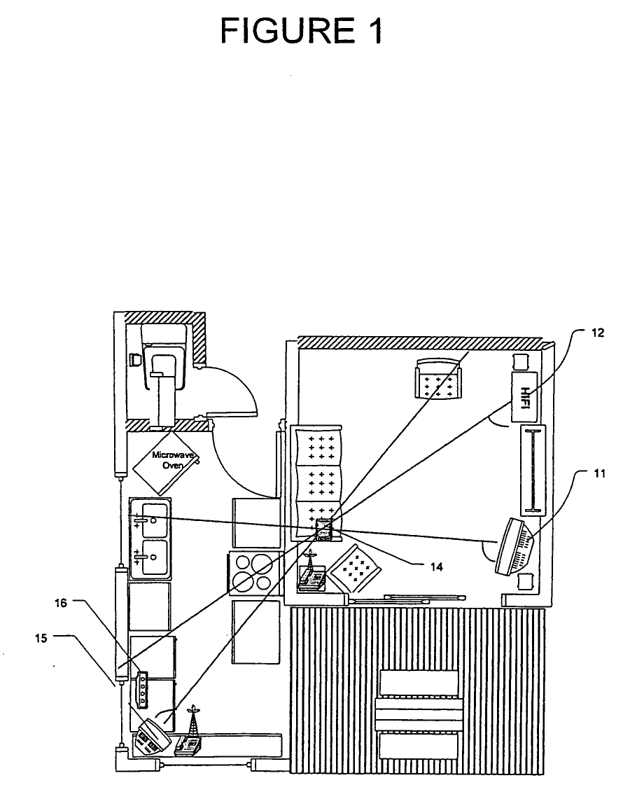

FIG. 1 illustrates a network according to one embodiment of the invention for locating a remote device.

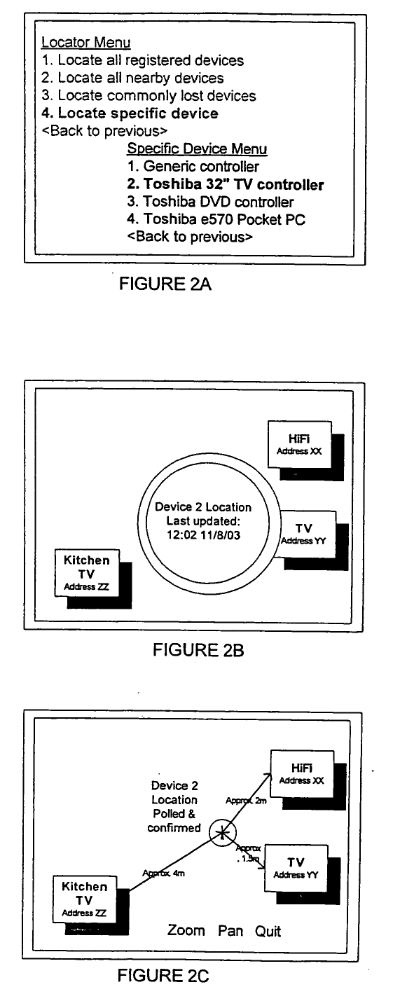

FIGS. 2a, 2b and 2c illustrate three different stages of a graphical user interface according to an embodiment of the invention.

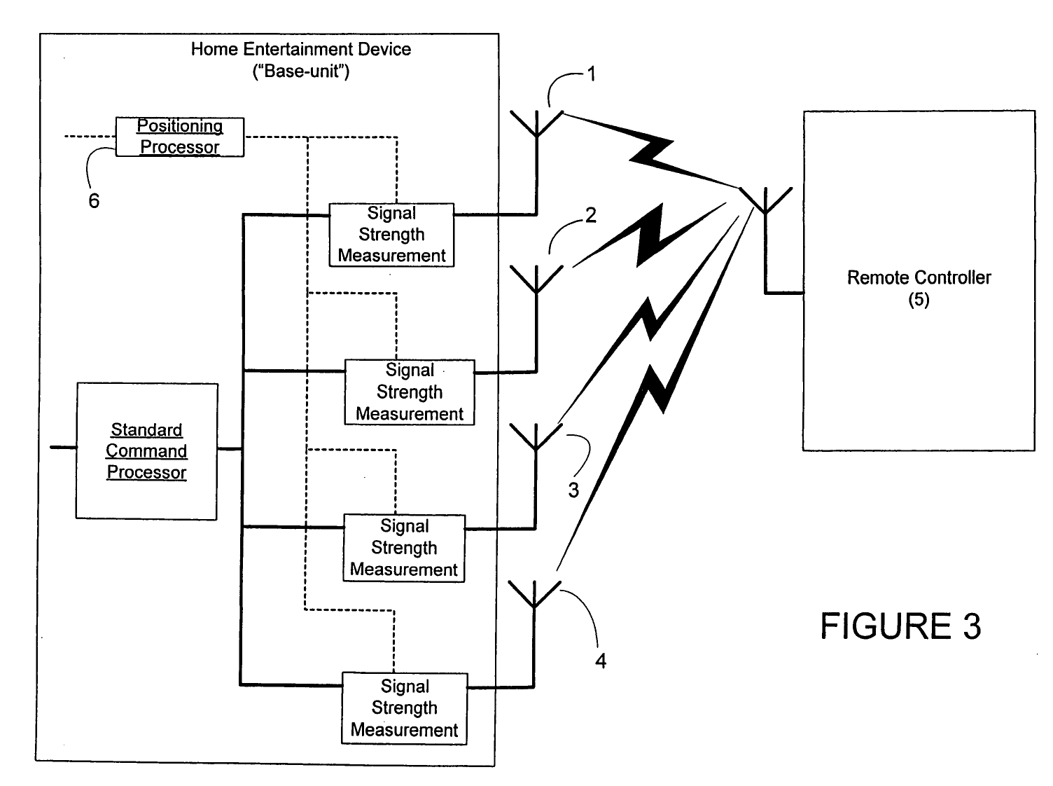

FIG. 3 illustrates a remote controller emitting a location signal towards a home entertainment unit with a four-antenna array according to an embodiment of the invention.

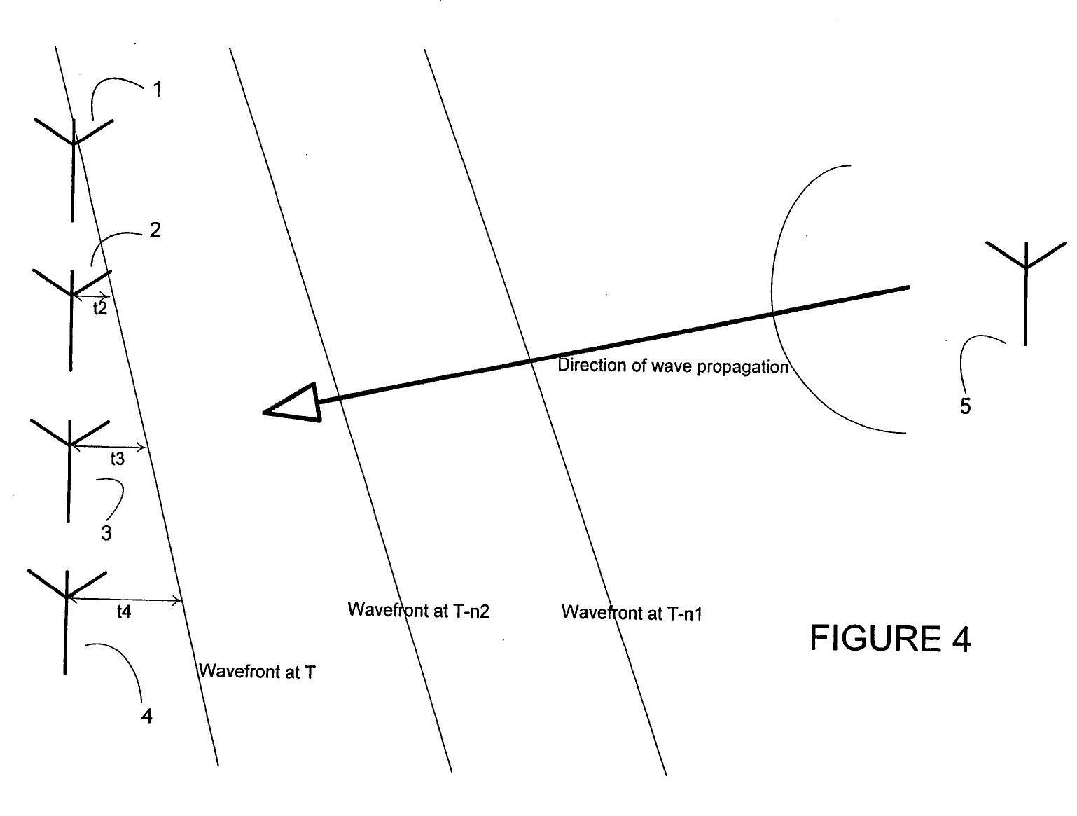

FIG. 4 illustrates how a location signal would propagate as a wavefront towards the home entertainment unit shown in FIG. 3.

With reference to FIG. 1, a schematic illustration is provided of a home environment. In one room a number of electronic devices are located, including a television 11 and a hi-fi system 12. In this room, a remote control device 14, say for the hi-fi system is also located on a sofa. In an adjacent room, a second television 15 is located, as well as a radio 16. Each of these devices (11, 12, 15) is associated with at least one antenna for receiving signals from the remote control device via a radio frequency carrier. An advantage of using a radio frequency carrier over the traditional infrared is that line of sight is not a requirement for communication, so the remote control 14 can communicate with, for instance, appliances that are in neighbouring rooms.

Each of the electronic devices (11, 12, 15) is in communicable relation, such as by being linked together through a high capacity hardwired or wireless local area network (LAN). This allows the electronic devices to share the information received by their respective antennas.

Preferably each of the devices has an antenna array, in order to assist in determining directional information for any received signals. In this regard, if the devices are configured for usage in a high capacity wireless system, they are likely to be already installed with multiple antennas, whether for simple receive diversity, for more advance MIMO (multiple input, multiple output) space time coding or for beam-forming. Advantageously these existing multiple antennas can be used in embodiments of the present invention to permit determination of the angle of incidence of the incoming radio signal, the significance of which will be described below.

The linked electronic devices (11, 12, 15) are associated with a processor. When each of the electronic devices receives information via their antennas, they send the received information through the LAN to the processor. The signals sent can be the raw received signals, or alternatively, some processing may occur at the receiving device, such as an A/D conversion or even angle of incidence/signal strength determination, as required.

The processor is associated with a graphical user interface (GUI) that may be displayed on one or more of the linked electronic devices, which have a display. The GUI may be configured so that it can be called up on only one of the electronic devices with a display, or any such device.

The processor may be part of a stand-alone device that is introduced to the network of linked electronic devices. In this embodiment, the processor would be associated with a user interface, such a mouse or directional pad, and be connectable to a display device, such as a television. The stand-alone device, alternatively or in addition, may have its own display. In a still further alternative, the processor may be implemented as a software program that is downloaded onto a computer (being one of the networked electronic devices) and run by the computer's existing processor.

To enable the system to operate, the processor is initialised with positional information relating to each of the electronic devices. For instance, the GUI can be provided with a drag-and-drop interface, which allows the user to sketch out the layout of the home entertainment devices in the room. The user can then add information relating to the position of each electronic device in the network. Each device is also assigned an address or other ID, which the device transmits to the processor together with any signals received from a remote device, so that the processor knows the source of the information.

Alternatively, as the system starts up and the interconnected devices all identify each other, they could provide the positional information themselves so that they can locate each other and present a topographical map of the home layout automatically. This is the preferred embodiment, as where the devices are capable of locating each other, they can cope with being moved around the room, as the devices could be configured to update their relative positions and hence the topographical map.

To the building layout, the user could also add information on barriers that are likely to affect signal reception, such as walls, and have an adjustment factor to account for the barrier. In this regard, where the system performs automatic mapping and tries to estimate distance on the basis of received signal level, then it would get distances massively wrong if there was a wall in the way (i.e. it would think a device was a lot further away than it really was). As such, by giving the user the ability to drag-and-drop “walls” into the GUI map would address this problem. Further accuracy can be achieved by providing the user with a choice of different wall types, to account of different attenuation factors. For instance, the user could choose between “solid brick” or “partition” walls.

In operation, when a user is not able to locate the remote control, for instance, they would utilise a user interface to call up an on-screen menu of the GUI on an appropriate display device, such as the television 11. The user interface could be controls on the stand-alone processor device, on the electronic device with the display itself (such as the television) or via another remote control.

An example of such an on-screen menu is shown in FIG. 2A. In this example, the user is given a number of options, being to:
1. Locate all registered devices
2. Locate all nearby devices
3. Locate commonly lost devices
4. Locate a specific device

In this example the user has opened up the fourth menu option, to “locate specific device”, and a number of options in this sub-menu are also displayed being:
4.1 Generic controller
4.2 Toshiba 32″ TV controller
4.3 Toshiba DVD controller
4.4 Toshiba e570 Pocket PC″

The user has highlighted sub-menu item 4.2, via their user interface, to locate the television controller.

Once the user has made a selection, the processor preferably has a number of options. For instance, the processor can poll the selected device to determine its location. Alternatively, or in addition, the processor can maintain a record of where each remote controller was last located. If for instance the last time this record was updated was only a short period of time ago (i.e. less than a predetermined threshold time period), the processor may decide to inform the user of this last location without undertaking a polling operation. If, however the last update was more than the predetermined time threshold, then the processor would decide to undertake the polling operation. Alternatively the user can override this and request the processor to undertake a polling operation regardless of when the last update occurred.

In another embodiment of the invention, to maintain the location database, each of the remote devices associated with the network periodically update their location with the processor. This may be achieved by the processor sending a polling location update signal every half hour, for example. This periodic update is preferably configurable, so that each device can be given its own update duration, which could be dependent on the likelihood of the device being lost. Therefore remote devices lost most often are configured to send update signals more regularly than those that are not. The remote devices may themselves be configured to send location information, without the need for polling, but is it preferred to maintain the processor as a central controller.

Alternatively, or in addition to these update periods, devices can be configured to derive location information from signals transmitted by the remote device in its normal usage. For instance, whenever a user presses a button on the remote control device, the remote control device is configured to transmit the appropriate command to its associated electronic device or devices. According to this embodiment of the invention, whenever the remote device transmits its appropriate command, the home entertainment devices in the network also receive the transmitted signal and from that can derive location information about the remote device. Therefore, in effect, the location information is being obtained “for free”. Preferably the transmitted signal includes an ID code so that the home entertainment devices can distinguish between a plurality of remote controls, where applicable. This feature provides enhanced efficiency, as it minimises power usage by virtue of combining the transmission tasks.

In the polling process, the processor transmits a signal to the designated device to be found. It is to be appreciated that were the menu option to “locate all registered devices”, as shown in FIG. 2A, be selected by the user, the polling process would require the processor to poll all the devices, so multiple request signals would be transmitted.

If a polled remote control is within transmission range it will emit a signal in response to the polling signal. The location signal transmitted by the remote device (14) would then be received by the receivers associated with the electronic devices (11, 12, 15, 16) provided they are within reception range. In the FIG. 1 example, the receivers on the hi-fi 12 and the televisions 11, 15 received the emitted signal. Upon receipt of the signal, the devices associate their ID with the received signal and forward it to the processor for processing. Where the device (11, 12, 15, 16) has multiple antennas, it is able to identify which antennas within the array received the strongest signal and thereby provide a more accurate signal strength/directional determination. Some processing may be performed at the receiving device itself, but it is preferred to undertake all processing at one centralised processor location to take into account the measurements from all receiving devices.

The processor then processes the signals received from each of the electronic devices to determine the likely location of the remote control 14.

This can be performed in a number of ways. Should the processor only receive one signal from an electronic device, it can obtain location information from this signal, although the accuracy will not be high. For instance, if the hi-fi 12 were the only device to receive the signal transmitted from the remote control 14, the processor would determine the power strength of the received signal in order to estimate the distance to the remote control 14. In this regard, knowing the signal strength enables an approximate distance from the antenna to be determined, at which the remote control is transmitting the signal. Further, knowing the direction in which the antenna is directed, provides further accuracy to the positional estimation.

According to another embodiment of the invention, where two or more electronic devices receive the signal transmitted by the remote control, an approach utilising triangulation can be utilised. Triangulation can be performed with a minimum of two electronic devices as reference points, although the greater the number of points, the greater the accuracy. Greater accuracy can be achieved with more reference points, as factors such as signal attenuation, refraction and distortion, as a result of intervening walls and other objects can be accounted for. In this regard referring to FIG. 1, where three electronic devices receive the signal transmitted by the remote device, it is to be appreciated that the distance estimate from the television (15) in the adjacent room would be attenuated due to having to pass through the wall, and the direction estimate would be affected by diffraction effects through the wall. Hence, by incorporating estimates from multiple reference points, this error can be minimised.

Triangulation involves estimating the position of the transmitting remote control by measuring the radial distance and/or the direction of the received signal from two or more different points. That is, this triangulation approach uses geometry to estimate the location of the remote control.

To further describe the triangulation approach according to an embodiment of the present invention, with reference to FIG. 3, the receiving home equipment device has a four-antenna array, with antennas (1, 2, 3, 4). The remote controller 5 emits either a specific location “ping” signal, being a simple signal containing just device ID, or a regular command signal. When a signal is received from the remote controller (5), each antenna in the array receives the signal at both a different strength (proportional to distance) and a different delay (also proportional to distance). These signal strengths are reported to the positioning processor entity (6) of the device. The average received signal strength gives the approximate distance to the transmitter. This can be achieved using the elementary inverse-square law for radio propagation, or a more advanced model. The relative received signal strengths at each antenna gives one indication of the direction of the transmitter, in that the remote control 5 should be closest to the greatest measurements, which in this example would be provided by antennas 1 and 2. Also, the phase difference (delay) between the received signals also gives the angle of the wavefront incident on the antenna array.

The home entertainment device also has a standard command processor, which preferably optimally combines the command signals received by the device and presents the combined signal to higher software layers for action. The location signals are discarded.

FIG. 4 shows how the delayed wavefront, incident on the antenna array of FIG. 3 can be envisioned: the idealised spherical wavefront propagating from the transmitter (5) can be considered to be effectively a straight line at any appreciable distance. The time at which each antenna receives the signal is delayed according to the angle of that wavefront as is arrives at the antenna array, so the four antennas (1, 2, 3, 4) receive the signal at T, T+t2, T+t3 and T+t4 respectively). From these delay periods, the angle of the incident wavefront can be calculated.

These estimations of distance (ranging) and direction are collated and forwarded to the central GUI for presentation to the user.

While the processor is undertaking the triangulation determination, the user is presented with a GUI illustrating the relative positions of all the devices (11, 12, 15, 16). In a preferred embodiment, as the processor is undertaking the determination, the graphical illustration starts off by showing large regions of confidence within which the device could be found, and becomes progressively smaller as the triangulation process refines the accuracy of the position. This is illustrated in relation to FIG. 2B, where a general region of where the device being searched for is provided, together with an indication of the time that that search was last undertaken. This initial map display has a large region of uncertainty as to the location of the device. Then in FIG. 2C, the estimated position of the remote device is graphically indicated between the three devices (11, 12 and 15) involved in the triangulation operation. The illustration indicates that the remote device (14) is approximately 2 m from the hi-fi, 1.5 m from the television (12) and approximately 4m from the television (15) in the adjacent room. Approximate directions from each of the devices (1 1, 12, 15) are also illustrated, such as using arrows.

Therefore in this way, this embodiment of the present invention not only utilises radio communications to locate a remote control in a given area, but provides a user with a visual illustration of the estimated location via a graphical user interface. This interface also provides the user with various other interactive features, enabling them to locate a number of different devices at one time and also to maintain a general monitor on the location of the remote controls, particularly ones that are regularly lost. This functionality is preferably provided using an interface with the user's existing electronic equipment, such as existing home entertainment equipment.

In another embodiment of the invention, another functionality that the GUI can provide in the triangulation process is to initially display the region “where it is usually found” or “where it was last found” and then zoom in on the estimated located as the triangulation procedure is completed. Additionally, where multiple remote controls are associated with the networked devices, the graphical illustration could also show the locations of the other remote controls

Alterations and additions are possible within the general inventive concepts. The embodiments of the invention are to be considered as illustrations of the inventions and not necessarily limiting on the general inventive concepts.

For example, in a home environment, all of the home entertainment devices in the house need not be linked to effect the embodiments of the present invention. A number of strategically positioned electronic devices may be selected instead. At least one of the electronic devices preferably should have a display and be configured to provide the user with a graphical indication of the location of the remote device.

Additionally, the system may be supplemented further with intelligent heuristics that can not only identify frequently misplaced controllers but also maintain a record of their location and use that to determine patterns in the movement of these frequently misplaced devices. For instance, if a child habitually hides the controller in a particular location, this heuristic feature could recognise this.

Also, the remote controllers in these embodiments of the invention may have an acoustic beeper incorporated, which is preferably configured to be activated after a predetermined duration has elapsed from the user activating a polling request. This would allow the user to find the device aurally if the user was unable to find the device using the triangulation approach. In this way the usage of the beeper could be minimised, and the battery conserved. Further, the user is likely to be near the device once the beeper sounds, so with this combination, the user should find the remote control fairly quickly, which again would restrict the battery usage by the audio transducer.

Further, in a more traditional, wired home entertainment system, where a remote control's primary communication is infrared, the embodiments of the present invention could be implemented using Bluetooth or a similar low cost radio frequency technology. In this implementation, a Bluetooth module could be attached or built in to the remote control and also to the home entertainment equipment and arrayed around the home forming a network of locator positions. While this implementation would be of reduced complexity, it would also be of reduced accuracy in view of the limited capabilities of such transceivers.

Whilst the embodiments have been described with respect to infra red transmitters, an alternative means of communicating with the home entertainment equipment is possible, for example wireless control signals, including the remote control device as part of a wireless local area network. Some remote control devices may even be coupled to their respective equipment by cable. Also other EM frequencies may be used, for example a low-powered laser rather than infra red which would give much higher data throughput for the sending of complex commands.

By remote control device, the embodiments are describing device used in the remote operation and/or control of electronic equipment, particularly home entertainment electronic devices including amplifiers, CD players/recorders, minidisk decks, tape decks, DVD players/recorders, computers, scanners, televisions, video players/recorders, cable decoders (i.e. set top boxes), digital cameras and camcorders.

1. In a network comprising a plurality of electronic devices, a processor for use in locating one or more remote control devices, each remote device comprising a transmitter configured to transmit wireless signals, each of the electronic devices having a receiver configured to receive signals transmitted by each of the one or more remote device, the processor comprising:
means configured to receive signal information from the electronic devices, the signal information relating to signals transmitted by at least one of the one or more remote devices, as received the respective terminal;
means for determining a positional measurement from the received signal information; and
means for estimating a location of the at least one remote device, using the positional measurement or measurements.

2. The processor of claim 1, further comprising a user interface configured to allow a user to select one or more remote control devices to be located.

3. The processor of claim 1, further comprising a database configured to maintain a record of at least one of:
the last known location of each of the one or more remote controls; or
a location history for each of the one or more remote controls.

4. The processor of claim 1, further comprising a graphical user interface configured to provide a user with a visual indication of the location of a remote control device.

5. The processor of claim 4 wherein the graphical user interface is configured to be displayed on any one or more of the electronic devices having a display.

6. The processor of claim 1, wherein the graphical user interface further comprises a user selection means for activating a polling signal to locate one or more remote devices.

7. The processor of claim 1, further comprising means for determining a signal strength and/or a signal direction measurement for each of the at least one remote device from the received signal information.

8. The processor of claim 7 further comprising means for performing triangulation using the signal strength measurements and the signal direction measurements in order estimate the location of the one or more remote devices.

9. The processor of claim 1 wherein each electronic device is a home entertainment device, such as a television, a computer, a DVD player/recorder, a video player/recorder, a CD player/recorder, a stereo unit, an amplifier, a minidisk deck, a tape deck, a scanners or a cable decoder.

10. In a local area network, the network comprising a plurality of electronic devices and at least one remote control device associated with one of the electronic devices, a method of locating the at least one remote device comprising:
receiving signal information from the electronic devices, the signal information relating to a signal transmitted by at least one of the remote devices, as received the respective terminal;
determining a positional measurement from the received signal information; and
estimating a location of the remote device, using the positional measurement or measurements.

11. The method of claim 10 further comprising further comprising transmitting a polling signal to one or more of the remote devices in order to initiate the signal transmission by the one or more remote devices, upon receiving a user initiated polling instruction.

12. The method of claim 11 wherein the transmission of the polling signal is user initiated.

13. The method of claim 11, wherein the transmission of the polling signal is periodic.

14. The method of claim 11, wherein the positional measurement is a signal strength and/or a signal direction measurement.

15. The method of claim 14 further comprising performing triangulation using the signal strength measurements and/or the signal direction measurements in order to estimate the location.

16. The method of claim 11, further comprising providing a visual representation of the estimated location of the one or more remote devices on one or more of the electronic devices having displays.

17. The method of claim 11, wherein the one or more remote devices are configured to transmit signals periodically.

18. The method of claim 11, wherein the one or more remote devices are configured to transmit location information signals each time a user utilises the remote device to send remote commands.

19. A computer program product for use in locating one or more remote devices in a local area network, the network comprising a plurality of electronic devices, the computer program product comprising a computer usable medium having computer readable code thereon, including program code comprising instructions and data for causing a processor to perform the method according to claim 11.

20. Home entertainment equipment comprising a processor according to claim 1.
